(19) United States
(12) Patent Application Publication
(10) Pub. No.: US 2013/0321458 A1
(43) Pub. Date: Dec. 5, 2013

(54) CONTEXTUAL VISUALIZATION VIA CONFIGURABLE IP-SPACE MAPS

(71) Applicants: SCOTT B. MISERENDINO, BALTIMORE, MD (US); DAVID MORSBERGER, DAVIDSONVILLE, MD (US); WILLIAM E. FREEMAN, SYKESVILLE, MD (US); CHRISTOPHER CHARLES VALENTINO, STEVENSVILLE, MD (US)

(72) Inventors: SCOTT B. MISERENDINO, BALTIMORE, MD (US); DAVID MORSBERGER, DAVIDSONVILLE, MD (US); WILLIAM E. FREEMAN, SYKESVILLE, MD (US); CHRISTOPHER CHARLES VALENTINO, STEVENSVILLE, MD (US)

(73) Assignee: NORTHROP GRUMMAN SYSTEMS CORPORATION, FALLS CHURCH, VA (US)

(21) Appl. No.: 13/905,960

(22) Filed: May 30, 2013

Related U.S. Application Data
(60) Provisional application No. 61/653,259, filed on May 30, 2012.

(51) Int. Cl. G06T 11/60

(52) U.S. Cl. CPC G06T 11/60
USPC 345/629

(57) ABSTRACT

In one embodiment, a method includes generating a treemap for a network space having an array of network addresses. The treemap includes a hierarchical network map with a plurality of leaf nodes, and each leaf node in the treemap characterizes a proper subset of the array of network addresses. The method includes overlaying an organizational schema for an organization on to the hierarchical network map to identify a plurality of nodes of the network space employed by the organization. The method includes generating a visualization for a graphical user interface (GUI) of the hierarchical network map with the organizational schema overlaid thereon that includes a visual indicia of network events that occur within the network space.

### CROSS-REFERENCE TO RELATED APPLICATION

This application claims the benefit of U.S. Provisional Patent Application 61/653,259 filed on May 30, 2012, and entitled IP-SPACE VISUALIZATION AND MODULAR ANALYTIC FRAMEWORK, the entirety of which is incorporated by reference herein.

### TECHNICAL FIELD

The present invention relates generally to computer analytics, and more particularly to a system and method for generating contextual visualizations of IP-space.

### BACKGROUND

The need to scale visualization of cyber Internet Protocol space (IP-space) data sets and analytic results, as well as support a variety of data sources and missions have proved challenging requirements for the development of a cyber common operating picture. Typical methods of visualizing IP-space data require unreliable domain conversions such as IP geolocation, difficult to discover network topology, or can display only one data set at a time. There are three primary classes of visualizations applied to cyber data that attempt to add context to the data: geospatial maps, network graphs, and IP-space views. Geospatial maps use IP geolocation transforms to convert IP addresses to corresponding latitudes and longitudes to provide physical location context to the datasets. Network graphs are used to show physical and logical network connection context. Finally, IP-space views attempt to contextualize the dataset relative to the organization of the cyber domain. The following will describe some of the limitations with each of these visualization methods.

Since geospatial maps have both a meaningful and familiar frame of reference, many cyber visualizations tools incorporate them. To use the geospatial domain for cyber data set visualization, however, requires network elements to first be geolocated. The process of geolocation of network elements, typically referred to as IP geolocation, is subject to many difficulties. For instance, today's networks do not allow for wide-spread, reliable, high-resolution geolocation. Thus, IP geolocation is subject to many sources of error depending on the technique used to estimate the host's physical location. The relatively course resolution of these geolocation techniques causes network elements across an entire city, for example, to be binned together on the geospatial maps regardless of their nature, function, or owner. This binning behavior can result in the gross false correlation of network element data and severely limit the usefulness of geospatial displays for cyber situational awareness.

Another approach to visualization involves the use of network graphs. The location of elements in the visualization is driven by connections to other elements most often expressed in the form of network graphs. The application of this approach, however, relies on a detailed understanding of the network's topology. In some cases, this is a reasonable assumption, for example networks under the user's administrative control. For large enterprise networks or networks divided by many administrative domains, however, this topological data can be difficult to discover and maintain. If the goal is to visualize data going to or from a massive network, then the network graph approach is limited. Since access to most network domains is unavailable, a thorough connection-based approach to the display of global datasets is thus unrealistic.

Network graph-based visualizations must also solve the problem of how to place the nodes and edges within the visualization. There exists no absolute location for any network element. Typically, the elements are dynamically arranged to minimize visual clutter and/or to focus the user's attention on a particular part of the graph. Some tools allow the user to select from a variety of algorithms for generating the graph layout. In some layout algorithms, such as force-directed, as nodes and edges are added, removed, or moved in these graphs, the relative position of all the elements change. This forces users to reorient themselves every time data changes limiting the “at-a-glance” understanding of the domain and data. This visual instability is in stark contrast to geospatial displays, where, map elements maintain their relative positions.

Yet another visualization approach relates to IP-space visualization. In this approach, every externally reachable element on a network must have a unique IP address in some subnet, just as every physical object must have a unique position in physical space. Since every network element must be uniquely addressable, IP-space serves as a natural domain for network-centric data. Although less common than geospatial and network graphs, there exists a variety of approaches that use the organization of IP-space as the context for visualization. For example, IP-space can be treated as a bounded, discrete, one-dimensional domain which due to its size must be mapped to a two or three-dimensional domain for the purposes of visualization of data. The differences and potential value and drawbacks of IP-space approaches are based on the choice of mapping function which can be problematic depending on the dimensionality of the display.

### SUMMARY

In an aspect of the invention, a method is provided. The method includes generating a treemap for a network space having an array of network addresses. The treemap includes a hierarchical network map with a plurality of leaf nodes, and each leaf node in the treemap characterizes a proper subset of the array of network addresses. The method includes overlaying an organizational schema on to the hierarchical network map to identify a plurality of nodes of the network space employed by an organization. The method includes generating a visualization for a graphical user interface (GUI) of the hierarchical network map with the organizational schema overlaid thereon that includes a visual indicia of network events that occur within the network space.

In another aspect, a system includes a map module to generate a hierarchical network map for a network space including an array of network addresses. The hierarchical network map includes a treemap with a plurality of leaf nodes. Each leaf node in the treemap characterizes a proper subset of the array of network addresses. The system includes an interface to specify an organizational schema for an organization and to identify a plurality of nodes of the network space employed by the organization. A visualization module to generate a visualization for a graphical user interface (GUI) of the hierarchical network map with the organizational schema overlaid thereon that includes a visual indicia of network events that occur within the network space.

In yet another aspect, a non-transitory computer readable medium includes computer executable instructions that when executed cause a processor to generate a treemap for a network space comprising an array of network addresses. The treemap includes a hierarchical network map with a plurality of leaf nodes. Each leaf node in the hierarchical network map characterizes a proper subset of the array of network addresses. The instructions also cause a processor to overlay an organizational schema for an organization on to the hierarchical network map to identify a plurality of nodes of the network space employed by the organization. The instructions also generate a visualization for a graphical user interface (GUI) of the hierarchical network map with the organizational schema overlaid thereon that includes a visual indicia of network events that occur within the network space.

In still another aspect, a method is provided. The method includes processing a network map hierarchy corresponding to network ownership data. The network ownership data maps at least one of an address block of a network and an organizational name to an identifier. The method includes assigning the network ownership data to at least one tier in the network map hierarchy. The method includes determining a virtual space for the network ownership data in the network map hierarchy. The method includes determining a location of a network dataset that characterizes an organizational schema within the virtual space. The method includes outputting a visual representation of the virtual space that includes an indicium identifying the determined location of the network dataset.

### BRIEF DESCRIPTION OF THE DRAWINGS

FIG. 1 illustrates a system for generating a visualization from configurable network space maps in accordance with an aspect of the present invention.

FIG. 2 illustrates an example visualization in accordance with an aspect of the present invention.

FIG. 3 illustrates an example organizational structure in accordance with an aspect of the present invention.

FIG. 4 illustrates an example map generator and visualization tool in accordance with an aspect of the present invention.

FIG. 5 illustrates a system for analyzing and visualizing data sets in accordance with an aspect of the present invention.

FIG. 6 illustrates an example output visualization in accordance with an aspect of the present invention.

FIG. 7 illustrates an example analytic interface in accordance with an aspect of the present invention.

FIG. 8 illustrates an example of a hierarchically organized IP-space visualization in accordance with an aspect of the present invention.

FIG. 9 illustrates an example output depicting threat status symbols in accordance with an aspect of the present invention.

FIG. 10 illustrates an example geospatial situational awareness visualization in accordance with an aspect of the present invention.

FIG. 11 illustrates an example system for analyzing and visualizing datasets in accordance with an aspect of the present invention.

FIG. 12 illustrates a methodology for map generation and dataset visualization in accordance with an aspect of the present invention.

FIG. 13 illustrates a methodology for generating a visualization from configurable network space maps in accordance with an aspect of the present invention.

### DETAILED DESCRIPTION

Systems and methods are provided for visualization of cyber domain information to enhance understanding of network events and enable a common view of cyberspace via configurable Internet Protocol space (IP-space) maps. The IP space is a category of computer network space which is defined by a range of computer addresses. The systems and methods disclosed herein produce scalable, user-definable visualizations of IP-space that process a dynamic range of events from several tens of hosts to the global Internet containing several billion hosts, for example. This can include transforming tools developed for visualization in the geospatial domain into the cyber domain, for example. By first visualizing the entire cyber domain, or regions of interest within that domain, any dataset with an IP address field can be layered on top of the IP-space maps just as datasets with latitude and longitude fields can be layered on geospatial maps, for example. Dataset context is made clearer by controlling or reconfiguring the organization of the IP-space maps. Furthermore, clusters within the dataset can be visually and analytically identified relative to the structure of the map. A web-based user interface allows multiple users or even multiple organizations to leverage a single software installation. An application programming interface (API) allows users to easily incorporate the visualization technique into existing cyber situational awareness applications, for example.

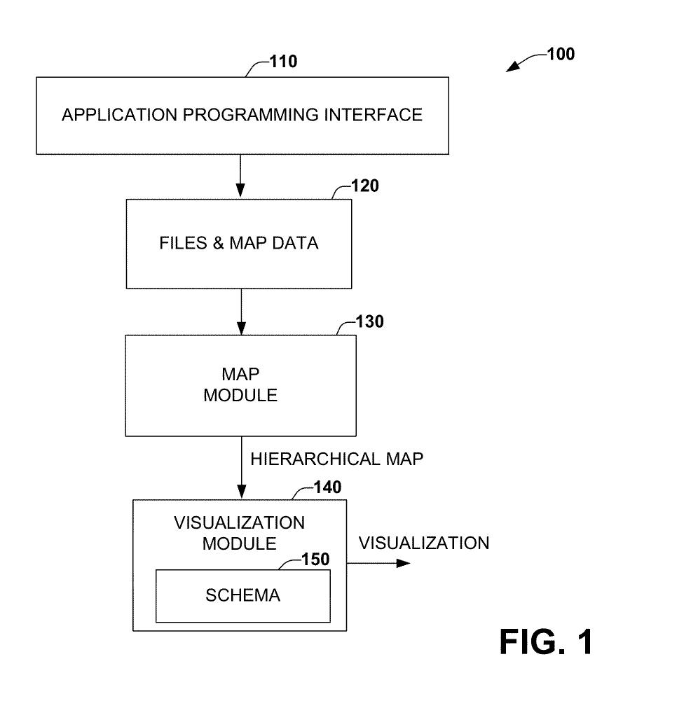

FIG. 1 illustrates a system 100 for generating a visualization from configurable network space maps. The need to scale visualization of network space (e.g., IP-space) data sets and analytic results, as well as support a variety of data sources and missions have proved challenging requirements for the development of a cyber common operating framework. For instance, typical methods of visualizing IP-space data require unreliable domain conversions such as IP geolocation, difficult to discover network topology, or can display only one data set at a time. The system 100 provides a generalized version of hierarchical network maps also referred to as configurable IP-space maps that can concurrently visualize multiple layers of IP-based data at global scale (e.g., multiple levels of visualization detail contextually overlaid on to a global map scaled for viewing). The network space maps allow users to interactively explore the cyber domain (e.g., computer network domain) from multiple perspectives.

As shown in FIG. 1, the system 100 includes an application programming interface (API) 110 (also referred to as a markup language interface) where a user can classify network space data (e.g., IP-space data) according to a hierarchical map. The API generates various files and map data 120 such as what types of organizational structures are involved, hierarchy relationships between tree members of a hierarchy, and other map details that will ultimately appear on a given visualization and provide further context to the visualization. A map module 130 receives the file and map data 120 and generates a hierarchical map that is processed by a visualization module 140 to generate a visualization. The visualization module 140 can apply an organizational schema 150 on to the hierarchical map to define additional context for the network space. For example, additional context could imply overlaying an organization structure (e.g., icons representing portions of an organization) on top of a global network space map (e.g., IP-space map) where events can be monitored (e.g., monitor for targeted cyber attack events on designated points of an organization in context of a higher-order view of cyber space). The visualization module 140 can generate the visualization of the schema 150 in accordance with the hierarchical map to enable an understanding of network events that are associated with the network space. Network events can include any incoming or outgoing traffic from a given network address and/or range of addresses. As an alternative configuration, the schema 150 could also be specified in the files and map data 120 or could be located within the map module 130, for example.

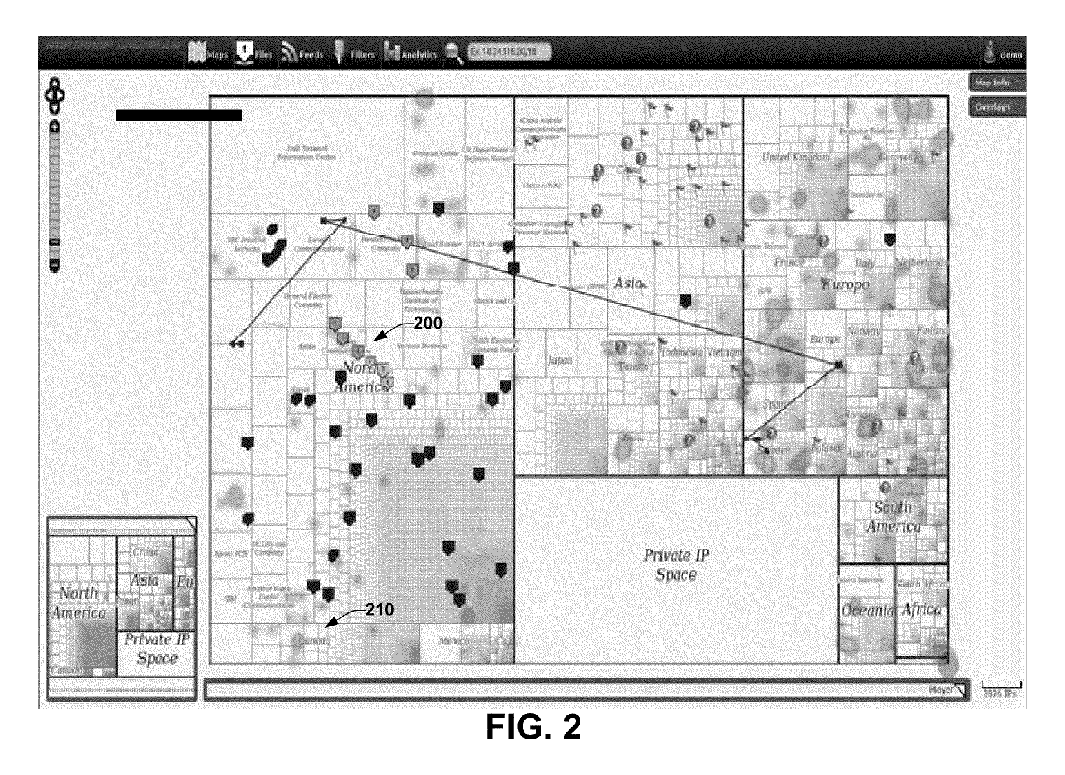

As noted above, the system 100 can generalize hierarchical network maps to add additional user-definability (e.g., for a cyber COP application) and improve information sharing through a web-based implementation, multi-user interface and dataset-agnostic input file. Hierarchical network maps are treemaps of the IP-space, for example, where leaf nodes are characterized by the number of IP addresses in a subnet and the levels of the tree are fixed as continent, country, ASN, and IP prefixes. The tree levels determine the nesting of labeled, rectangular boxes within the visualization. The nesting effect can be observed in the example of FIG. 2. For example, the element of North America at 200 illustrates that the content level can have a child node of Canada at 210 and in the visual display the box representing North America can contain a box representing Canada. The hierarchical network maps concurrently optimize display space utilization, layout preservation, geographic awareness, and rectangle aspect ratio, for example. Thus, the network space maps generalize the hierarchical map concept of hierarchical trees by allowing any user-defined hierarchy ending in an IP subnet level, for example, including hierarchies that are unbounded by a geospatial context (or other context).

Referring back to FIG. 1, each IP address or block of addresses, known as a subnet, can be “owned” by a series of progressively larger, more encompassing entities. By imposing an organizational schema 150 onto the full IP-space, the location of individual elements thus becomes meaningful and in context. The globally routable IP-space can be regulated in this hierarchical manner. Each globally routable IP address should be allocated by one of the five regional internet registries (RIRs). The five RIRs allocate blocks of IP address to large Internet service providers and other micro-end users. The ISPs and other independent service providers often subdivide RIR allocations to smaller organizations and report that information to the RIRs as SWIPs (Shared WHOIS Project data). By basing an organizational schema on the naturally occurring ownership data provided and maintained by the RIRs, globally routable IP-space can be meaningfully visualized without the need for connectivity data using the IP-space map concept.

The default IP-space map levels for globally routable addresses can be continent, country, ISP, organization, and host/subnet, for example. During visualization, the host/subnet level may not be used but the collection of subnets within an organization does help to determine the location of individual IP address on the IP-space map. While this default IP-space hierarchy structure provides some geospatial or geopolitical context to the map at the highest levels, it provides value not previously achievable with a traditional geospatial map. Many other hierarchical organizations of the space are possible that can add additional context.

Often companies or organizations will allocate portions of their IP-space (whether globally routable or private) to individual sub-organizations, agencies, buildings, functions, or departments according to some hierarchical structure. Using IP-space maps, users can view their network data relative to these custom organizational structures. Using these specialized maps perhaps in conjunction with global maps of the public IP-space, network analysts can gain a complete contextual understanding of who is the source or destination of particular network events.

Before proceeding, some discussion of an example language that can be employed with the API 110 to generate the files and map data 120 is provided. Network data should be layered onto the IP-space maps for them to be useful as part of a cyber common operating picture. Network data is often multi-dimensional including fields such as IP address, time, port, protocol, metadata about the network traffic, or results of analytic processing. In one example, a cyber mark-up language (CML) can be employed by the API 110 that is tailored to the cyber domain based on the approach of input file formats for geospatial maps, such as shapefiles and keyhole markup language (KML), for example. The CML can be an eXtensible markup language (XML) file that focuses on how the data should be visualized rather than the structure of the data itself. Like KML, it is based on the concept of geometries plotted over the rendering of the background map. Supported geometry types include placemarks (a single IP address), lines (a list of IP addresses), and polygons (a subnet or block of IP addresses), for example. The CML allows users to decide geometry styling parameters such as color, line widths, and icon for placemarks. Unlike KML, it also allows an optional, generic, real-valued number to be assigned to a geometry that can be used to automatically control styling.

The choice to focus on visualization parameters rather than data structure has at least two benefits for a cyber COP application, for example. First, it allows users to share as little or as much detail about the geometry as they desire. Sharing is a goal in cyber security yet it is often hampered by legal and policy restrictions. With every organization having a different set of rules and regulations governing the type of data they can share, minimizing the requirements on data structure is useful. The CML typically requires the geometries' IP addresses. Second, the focus on visualization parameters ensures that regardless of the implementation of IP-space map selected, the resulting visualizations of the same CML file can be consistent. This allows CML to be portable and provides users across implementations a common platform for the data.

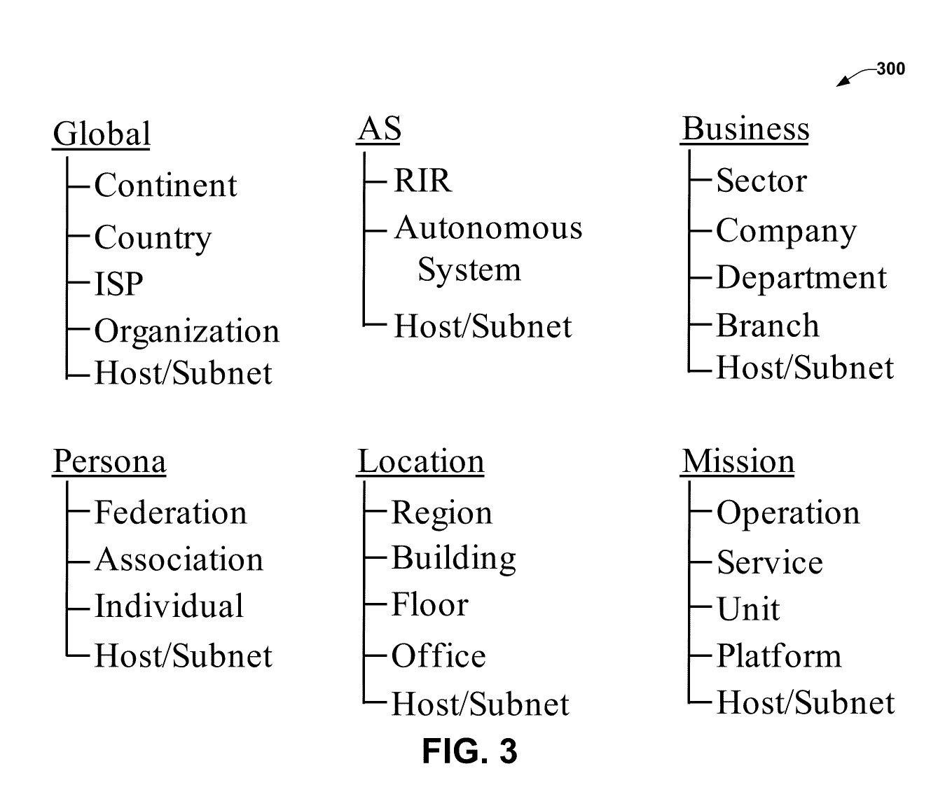

FIG. 3 illustrates an example organizational structure 300 in accordance with an aspect of the present invention. As shown, some of the example hierarchies in the structure 300 include a global structure, an autonomous system structure (AS), a business structure, a persona structure, a location structure, and a mission structure. More or less structures can be provided than the example structure 300. A variety of potential organizational structures for the IP-space are shown, some of which are alongside the default global structure. Using the RIR autonomous system assignments, an AS-based structure can be created. The business structure starts by organizing the space into business sectors, then individual companies, then department, branches, and so on within those companies. By selecting a number of representative companies from the Department of Homeland Securities sectors of the US infrastructure, for example, an IP-space map of US critical infrastructure can be generated having globally routable network assets. The persona structure can be based on individuals who may own a variety of network assets (such as desktops, laptops, virtual machine, and so forth) and grouping them by their associations and then federations of those associations. This type of structure may be useful for analysis of hacker groups, terrorist organizations, or advanced state-sponsored network threats, for example.

A location hierarchy is also possible where a large organization is broken up into its physical locations first by region, then building, then floor, and finally down to an individual office, for example. For military users, a mission hierarchy may provide utility with the IP-space broken down into operations, services, units, and platforms, for example. Using an organization's IT asset management databases, the data for these maps can be generated. For dynamic IP address assignment, the entire address block (or potions thereof) can be assigned to the appropriate parent element. Based on the user-configurable structures, IP-space maps can apply operational context to the visualization of network events detected by host-based security systems and network intrusion detection systems, for example.

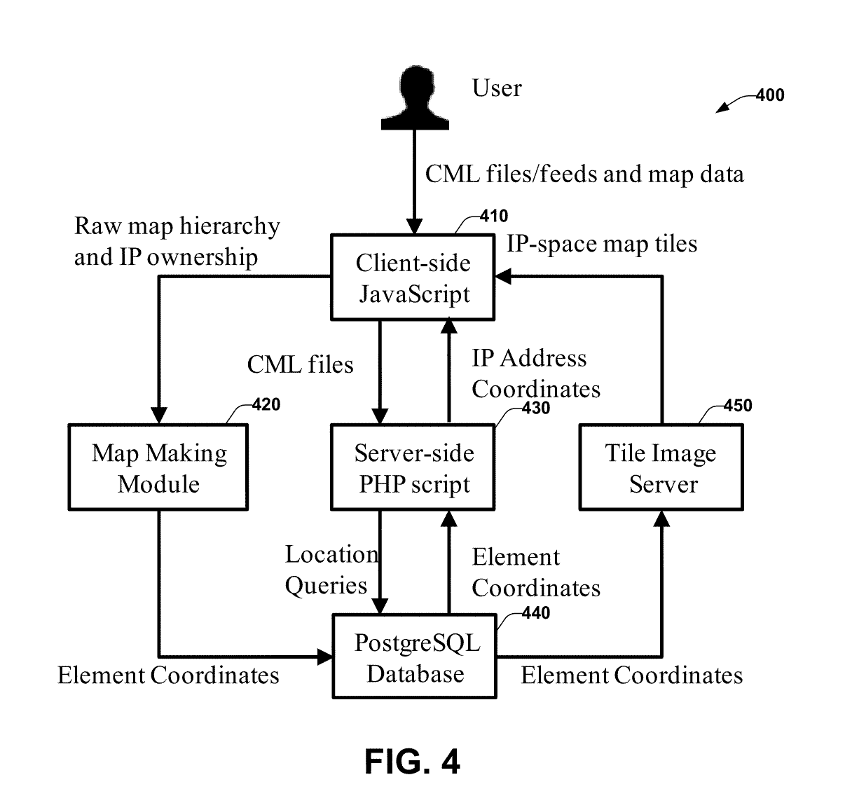

FIG. 4 illustrates an example map generator and visualization tool 400 in accordance with an aspect of the present invention. The system 400 can include a client-side JAVA script tool 410 to process user inputs files and data such as the cyber markup language (CML) files and map data described above with respect to FIG. 1. The script tool 410 outputs raw hierarchy and IP ownership data to a map making module 420 and also outputs CML to a server-side personal homepage (PHP) script tool 430 that returns IP address coordinates to the script tool 410. The map making module outputs element coordinates to an SQL database 440 (e.g., Postegre) which outputs element coordinates to the PHP script tool 430 and to a tile image server 450. The tile image server 450 outputs IP-space map tiles which are employed by the script tool 410 to generate a given visualization.

In the example system 400, a web application implementation for the IP-space map is provided to minimize software deployment and maintenance complexity as well as to provide an opportunity for integration with other cyber security tool web-based interfaces. Other implementations are possible (e.g., in-house local client/server model). The system can be designed based on a repurposing of existing open source software originally designed for creating geospatial map widgets for websites, for example. The use of popular user interface concepts such as geometry-based data layers and map image tiles based on open source software components provides for a familiar interface for user interaction. Other interfaces and/or software architectures are also possible.

The map making module 420 can be used to automatically construct an IP-space map and enter its data into the SQL database 440. The IP-space maps can be represented as a set of tables in the database 440, one for each level in a map's network hierarchy for example. The elements of each table contain a label or name for an element, a reference to an element in its parent's level, optionally a consecutive set of IP addresses belonging to that element, the total number of IPs associated with the label, and a set of box coordinates assigned by a treemap algorithm, for example. All first level elements reference a root node. All last level elements contain the IP address set. The same label may be used for multiple non-consecutive parts of the IP-space.

The raw map level data stored in the database 440 consists of a list of elements for each level and the consecutive parts of the IP space owned by that element. The number of IPs owned for each unique label is calculated and stored along with its percent of its parent elements IP-space. A squarified treemap algorithm can be used to assign each unique label a portion of the total map space. The squarified treepmap algorithm could be implemented, for example, as an algorithm that creates tiles (e.g., leafs) that are relatively close to square as compared to a treemap that has not been “squarified”. In some examples, the squarified treemap algorithm was selected to limit high-aspect ratio boxes making it easier to apply labels on the map and easier to read. Other treemap algorithms are also possible.

In a departure from traditional treemap implementations, the starting area to be partitioned may not be based on a physical viewing area. Since treemap algorithms attempt to completely fill the space provided, they must drop elements once an element's allocated size gets below a certain threshold. For instance, at only one pixel per IP address, the entire IPv4 space would take a display wall of 82,898×51,810 pixels. Since physical displays of appropriate size are not practical, a virtual display area is used with an area at least as large as the total number of IP addresses in the map. Thus, the virtual display is maintained at a suitable ratio of pixels to number of IP addresses, for example. The use of a virtual display allows the treemap to scale but should be processed for display over the web on computer monitors.

The virtual display for visualization is processed using a similar approach taken to scaling digital geospatial maps. The process includes dividing the map into image tiles of fixed size (e.g., 256×256 pixels) by creating tile sets for each resolution level. These tiled images are cached after generation for speed in later retrieval, and then stitched together client side at 410 according the user's current zoom level and region of view in a fully interactive map view.

In a GeoServer example, the tool can be configured to generate treemap tiles. Each level in the network architecture utilizes a styling file that controls how the boxes for that layer can be rendered. Then, visually separate hierarchy levels by color, boarder line thickness, and label font size with higher level tiers given thicker boarders and larger label font sizes. Then further, control label rendering as a function of goodness of fit within the element's rectangular box as rendered at a particular zoom level. Finally, at low zoom-levels, deeper levels of the hierarchy have the opacity of their boarders reduced. This gives the user a sense of where additional structure exists while limiting the visual clutter. A composite image can be created from individual renderings of each level. See FIG. 2 for an example of a global IP-space map based on a continent, country, ISP, and organization network hierarchy.

In some examples, the server-side PHP scripts 430 and SQL database 440 are responsible for calculating positions of IP addresses on a particular map. In such a situation, the database 440 holds records of the coordinates and associated subnets of the boxes generated by the map making module 420 treemap algorithm. In one example, an individual IP address location on a map is based on the coordinates of the bounding box of the parent element containing that IP address on the lowest level of the network hierarchy. The element of interest may contain other non-contiguous portions of the IP-space as well. Accordingly, in some examples, the IP addresses in the parent element are arranged in numerical order from lowest to highest and rastered from left to right across the box. In such examples, the center coordinates for each address are such that an integer number of rows and columns exist across the bounding box with the last row or column cell size adjusted to account for rounding in boundary box dimensions relative to the number of IP addresses contained. The center coordinates of an individual IP address can be calculated based on the location of that address in the ordered list of all addresses assigned to its parent element.

Data layers consist of geometry sets described in the CML format, for example. The client-side JavaScript ingests either static CML files or dynamic feeds of CML-formatted messages sending them to the backend web server. The server returns the location on the active map of IP addresses present in that dataset. The client-side JavaScript uses these map locations to plot the geometries on the IP-space map just as latitude and longitude are used to plot geometries on a geospatial map. The client-side code also supports several other data visualization options for the CML files including time lines, tables, and video-like playing of time stamped geometries. An atlas feature can be used to facilitate switching between various IP-space maps and a geospatial map. When a new active map is selected, the data layers should be reloaded since IP address locations are map dependent. The atlas provides the user a preview of the maps for which they have been granted access.

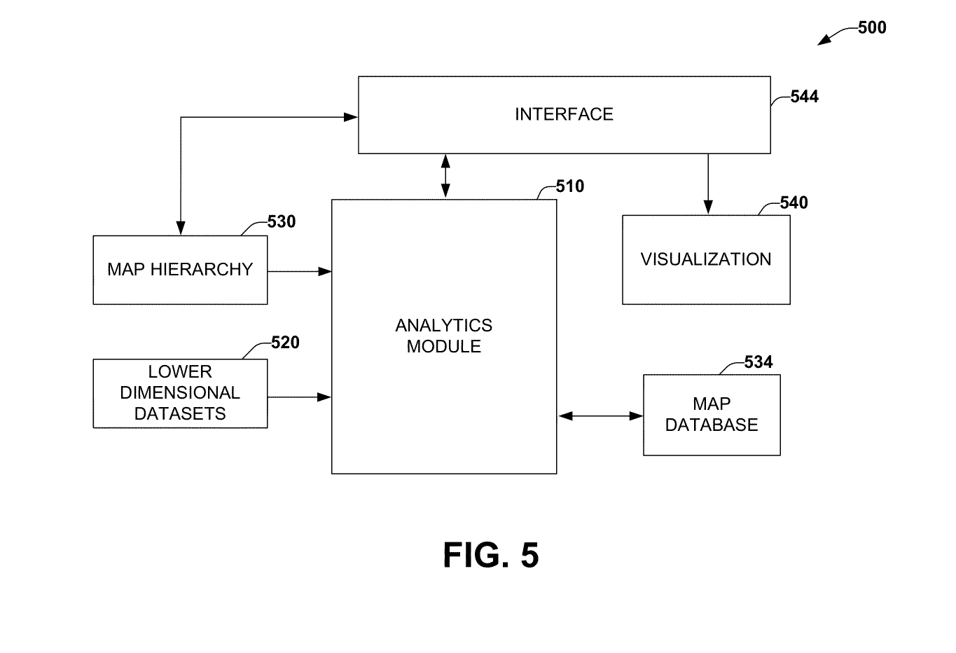

FIGS. 5-12 provide alternative systems and methods for analyzing and visualizing data in accordance with the present invention. In one aspect, a web tool allows users to view higher-dimensional maps generated from lower dimensional datasets such as IP-space. This includes generating analytics from pre-defined modules using graphical programming, and sharing results through an XML-based file format that includes descriptions of how the results should be displayed. The tool not only displays these maps of IP-space but generates them from network ownership datasets and user inputted hierarchical arrangements of IP addresses. The tool allows for many different maps and datasets to be viewed, including a geospatial map. Datasets can be overlaid on the map image and clustered based on the map's hierarchy of IP-space allowing users to draw insights into multiple datasets concurrently thereby improving their situational awareness of network activity.

The tool allows users to visualize network datasets (defined as any data associated with an IP address or addresses) based on multiple hierarchical organizations of the IP-domain or a subset thereof. Although developed for use on IP-space visualization, the tool also enables mapping and visualization to any countable, hierarchically-arranged datasets (e.g., phone numbers, names, email addresses, and so forth). Through this visualization, users gain an improved understanding of the behavior and intent of network devices, users, and systems—often referred to as cyber situational awareness. In addition, modular analytics allow the user to interact with network events such as netflow records, intrusion detection system events, and network device logs using a visual programming approach and predefined set of analytic modules, each performing an analytic task (e.g., such as filtering, de-duplication, correlation, and so forth).

The system enables representation of finite, discrete, hierarchically-organized, one-dimensional space (for example, IP-space) as a multidimensional treemap. Multiple independent hierarchical-organizations can also be enabled. In the case of a two-dimensional treemap, the treemap can be generated such that different regions are rendered independently to create tiles, wherein the tiles can be generated at multiple levels of resolution and dynamically exchanged during operation of the interface to create a zoom effect. Locations of unique elements of the discrete, one-dimensional space can be assigned unique locations on a Cartesian plane or set of higher dimensional axes. Graphical elements such as markers, boxes, and so forth can be placed over the treemap structure to highlight or call attention to certain coordinates.

FIG. 5 illustrates a system 500 for analyzing and visualizing data sets in accordance with an aspect of the present invention. The system 500 includes an analytics module 510 that receives multiple lower dimensional datasets 520 such as files containing network ownership data that maps IP address blocks or organization names to higher-level identifiers. These organizations and higher-level identifiers can form a single hierarchy, for example. A map hierarchy 530 can be defined by a user in a separate input file in which each ownership data file can be assigned to a tier in a map's hierarchy. In one aspect, the analytics module 510 processes network ownership files into tables in an ownership database and shown as map database 534. For each unique higher-level identifier at each map tier, a percent of total IP-space can be calculated. Using these percentage calculations, a virtual two-dimensional (2D) space can be partitioned using treemap algorithms, for example, starting at the highest map tier. Lower-tier elements can be nested within higher-tier elements using the same percentage calculation and treemap algorithm, wherein partitions labels from the ownership data input files can be added. The analytics module 510 then produces image tiles of the virtual 2D space at different resolutions levels and generates a visualization output 540 via interface 544 which is also employed to configure the analytics module 510 and manipulate user datasets.

In one example, the analytics module 510 uses treemap algorithms to develop two dimensional maps of the entire IP-space and then layers datasets described by their IP address or addresses. By visually displaying data in the IP-space, the need to use conventional IP geolocation transformations can be eliminated. The use of treemap algorithms on the structure of the IP-space based on ownership data as opposed to the common use of treemaps on the cyber datasets allows for multiple cyber datasets to be displayed concurrently via the visualization 540. The concurrent display is a visual method of testing for correlation among the various datasets. Furthermore, these maps are then tiled so that users can pan and zoom in and out to control the level of detail shown. FIGS. 2-6 described below will show various aspects of visualization, mapping, tiling, zooming and so forth of IP datasets. As noted above, other datasets than IP datasets can be processed by the system 500.

When users access the visualization output 540 through a web browser interface 544, for example, the appropriate tiles are downloaded to their browser given the users' requested resolution level. The interface 544 allows users to transition across resolution levels and pan across tile sets. The system 500 supports multiple maps concurrently and allows the user to switch between available maps. Additional maps can be created using new network ownership datasets 520 and map hierarchy 530, for example.

Using the web application interface 544, users can zoom into higher resolution tiles on a map. At a configurable resolution level, the analytics module 510 can query databases to determine the type of network element at each IP address visible in the current view. The results of the query can be displayed on the interface 544 as symbols, or icons, that are unique for each type of network element. Network element types include but are not limited to hosts, routers, switches, firewalls, intrusion detection systems, virtual machines, servers, and network storage devices, for example. By clicking on the symbol, the user can then use the interface to initiate focused queries or conduct configurable actions involving the selected IP address.

The analytics module 510 and interface 544 allows users to layer data sets on top of maps. The user may upload data files in a specialized format that identify what IP address, IP address block, or series of IP addresses (a route) they would like to highlight on the map. Users can also create, view, share, export, and edit data files through the interface 544. Data files can be represented as layers of geometries on the map such as place marks, polygons, and lines. Geometries can contain additional metadata describing the user's visualization preferences. Users can also click on visible geometries on the interface to display the metadata. The analytics module 510 queries the map database 534 and calculates the location of geometries within the virtual 2D space represented by the currently active (visible) map. The analytics module automatically clusters and declusters overlapping geometries as the user changes the resolution of the map. Locations of geometries can be different for each map and are calculated upon request as the user changes maps.

Data may also be provided to the analytics module 510 through a publication/subscription (pub/sub) mechanism, or stream. When visualizing streaming data, the analytics module 510 monitors a configurable topic on the pub/sub server for messages in a suitable data format. Messages published to this topic are ingested and treated similar to uploaded data files. A configurable number or history of published messages can be concurrently displayed at 540. For data files or streams containing time stamped geometries, the analytics module 510 can display a time series graph of the historic values of the geometries. This can include providing filters for the user to select subsets of the data or a more focused time frame to graph via the interface 544. The graphing interface 544 also allows other types of analysis including line and bar charts. The interface 544 can also provide message and data file summaries in tabular form.

Data layers can be created using an analytic workbench which can be provided as part of the interface 544 and analytic module 510. The analytic workbench can be a web application. Users can transition between the IP-space map displays and the analytic workbench using the web interface 544. The analytic workbench can consist of a series of modules that describe the configuration parameters, access method, expected output, and required input of external code not part of the system 500. The workbench allows users to select from the group of available analytic modules and drag them onto a workspace. Modules on the workspace present the user the available configuration parameters that the user should set. Modules can then be connected on the workspace to create an analytic workflow.

Upon a user's request to execute the workflow, the interface can connect to the appropriate external code and provide the user's configuration parameters. The analytics module 510 can coordinate the order of execution of the external code modules along with internal processing of results and mapping of outputs of one module to inputs of the next module in the analytic workflow. Status of each module in the workflow can be displayed through the interface 544, for example. Final results of the analytic workflow can be made available to the user in a variety of output formats including direct visualization on the IP-space maps at 540. Analytic workflows can be created, saved, edited, and shared using the interface 544. Workflows can also be automated and executed periodically upon appropriate configuration.

Users may create their own analytic modules or use those that are provided from the interface 544. The analytics module 510 includes modules to filter, summarize, and correlate IP-based datasets. Such datasets include but are not limited to netflow, PCAP, and intrusion detection system alert logs. Additional modules perform functions such as selection of a data source, conversion of data types, and export of results to various file types.

The interface 544 allows users to register personalized accounts. The user's accounts can be used to control access and permissions on maps, data layer files, configured data streams, and analytic workflows. Through the interface 544, users can create and join user groups. User groups share a set of privileges and access. User group membership and permissions can be managed by their creator or other appointed administrator. The interface 544 can enforce access permissions based on a user's attributes or profile regardless of group membership, for example.

Extensible mark-up language that describes how datasets 520 (e.g., IP datasets) are to be visualized. Descriptions can use IP addresses, for example, to uniquely identify the location of graphical elements. Graphical elements can optionally have an associated real number value. Clustering of graphical elements can cause mathematical functions to be performed on cluster's constituent element's real number values. Visual programming of cyber analytics can transform datasets 520 that exist over IP-space (or over the IP-domain). Non-sequential processing of analytic functions can be provided along with daisy-chaining of analytic functions using a common, shared data format. Daisy-chains may also include feedback loops (e.g., one module's output feeding back to its own input after additional processing).

Visualization of analytic and analytic component status can be provided (e.g., reports on if an analytic component is running, percent completion, resource usage, and so forth). Analytic structure (a description of the daisy-chain) can be saved as a sharable file. Use of graphical interfaces (analytic graphs) to control collection and eventing of an IDS, firewall, or cyber security product, for example, can be provided. Cyber security products can import analytic structure files and evaluate analytic results on streaming network datasets. In another aspect, rule sets can be generated to be used by other cyber security products.

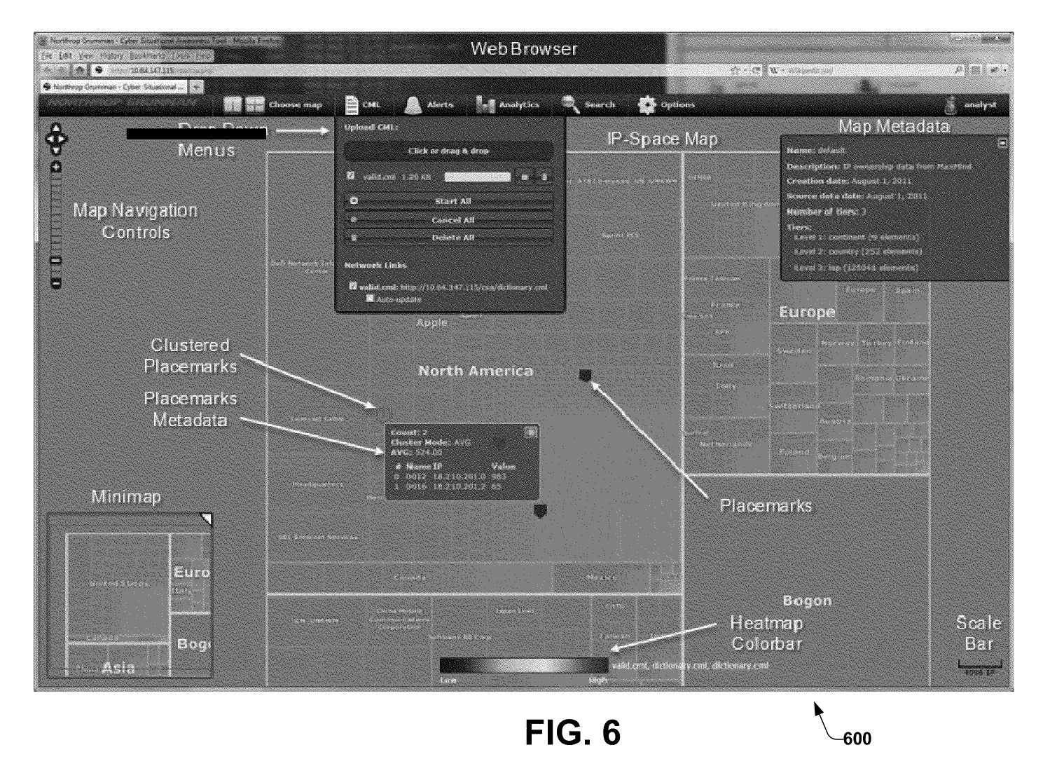

FIG. 6 illustrates an example output visualization 600 in accordance with an aspect of the present invention. The visualization 600 shows an example screen display from a visualization tool. In the visualization 600, a map of the global IP-space is organized by three hierarchical tiers: continents (yellow), countries (orange), and ISPs (blue). Place-marks have been placed on the map to show activity from individual IP addresses. Each place-mark can be assigned a numeric value that is displayed as a heat map, for example. Thus, a scalable IP-space visualization is based on organizing a one-dimensional IP-space into hierarchical tiers represented as a two-dimensional space or map. The visualization framework utilizes tiling, data layers, and zoom capabilities to provide analysts with the ability to view the level of detail required for their analysis. Analysts can use pre-defined hierarchies or define their own hierarchies best representing the IP-space they are analyzing. When applied, IP addresses can naturally cluster within (or outside of) the various hierarchical structures. Using the tool described herein, a network security analyst can zoom in on the suspicious clusters and view associated metadata for further investigation. Multiple viewpoints are available to the analyst as the tool can plot datasets concurrently using several IP-space maps, a geospatial map, or as tradition line and bar charts, for example.

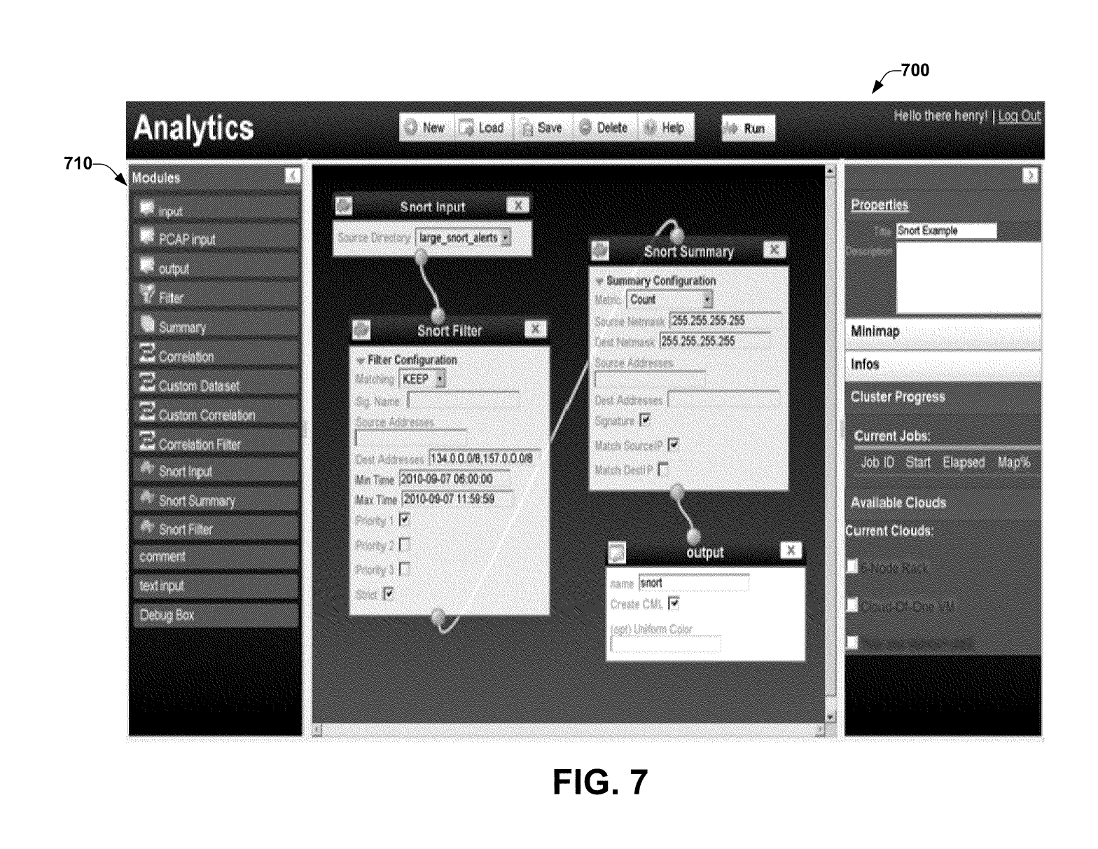

FIG. 7 illustrates an example analytic interface 700 in accordance with an aspect of the present invention. The interface 700 provides a modular, web-based cloud analytic framework for the analysis of large-scale cyber datasets. New analytic modules 710 can be created upon this framework providing additional viewpoints. Modules 710 provide specific capabilities such as reading a specific input data type, filtering, or performing transformations, for example. A web-based GUI can be employed to “wire” together and configure the pre-built modules 710 into new analytic workflows. The analytic GUI can interact with multiple data processing systems and initiate jobs across distributed infrastructure.

The modular approach allows analysts to interactively create new analytic workflows without: 1) developing code or 2) understanding complex algorithms such as map/reduce logic. The interface 700 includes an example filter and summarization analytic of an intrusion detection systems' events, wherein each module 710 can expose configuration parameters which analysts can use to fine tune the workflow. When executed, the workflow creates results files ready for the web-based visualization tool. A feature of these output files is that they can be shared among analysts, agencies, and/or organizations, for example. It is more efficient to share analytical results than to share the large datasets an analytic may consume in deriving the results.

Between the analytic framework and the visualization tool lies the results file whose format is referred to as Cyber Markup Language (CML). Analytics use fields within the CML specification to convey metadata to be displayed in the visualization tool. It includes information on how that data should be displayed along with preferences for geometry (e.g., placemarks, polygons, and so forth) styles. The CML can be an Extensible Markup Language (XML) based file format, for example. Using XML tags, the CML format can be extended to include additional data fields, preferences, and other parameters. The CML format can be evolved into an open industry standard for sharing CSA results between different tools—both analytical and visual. Existing tools can be modified to import CML and make use of CML specific metadata. Adoption of CML can allow for consistent use of labels, metadata, icons, colors, and line widths across multiple tools, for example.

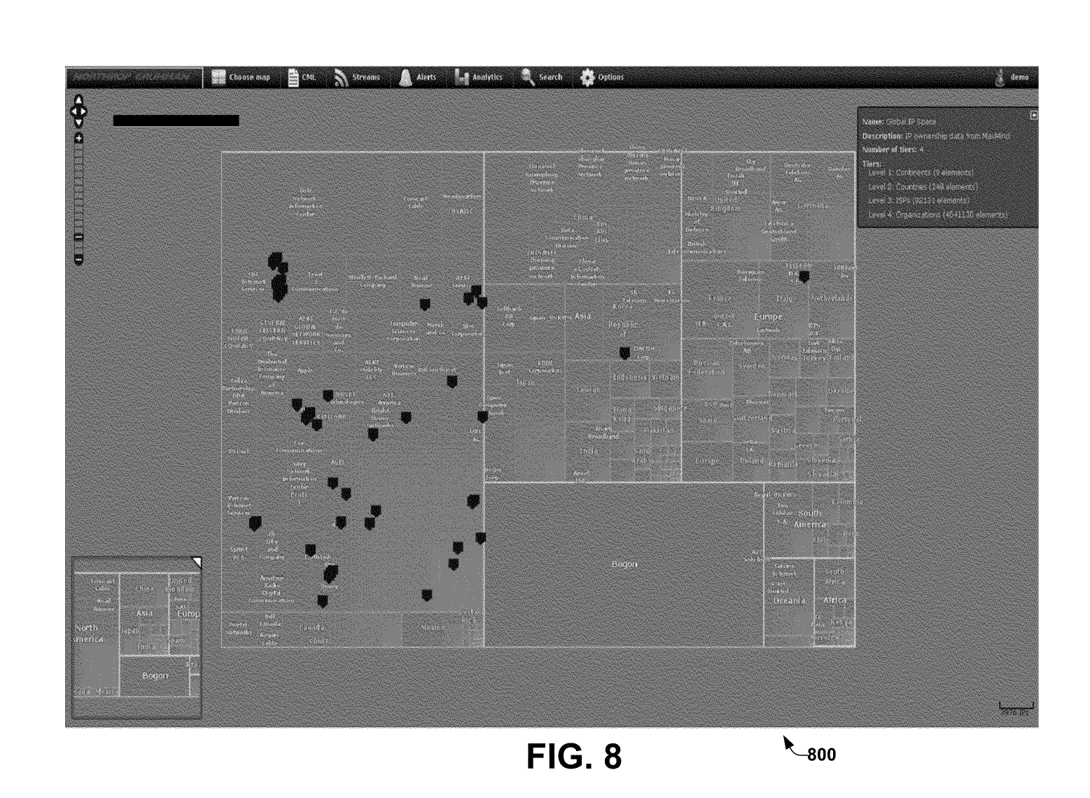

FIG. 8 illustrates an example of a hierarchically organized IP-space visualization 800 in accordance with an aspect of the present invention. In this aspect, an IP-space can be organized into hierarchical tiers, wherein each IP address or block of addresses is “owned” by a series of progressively larger, more encompassing entities. The particular hierarchical structure used can be either user-defined or, lacking a user-preference, based on the organization of the entire space derived from publically available IP registration databases. By imposing an organizational schema onto the full IP-space, the location of individual elements becomes more relevant. The globally routable IP-space is naturally regulated in this hierarchical manner.

The visualization 800 shows an example of global data sets displayed using a hierarchical-organization based on IP ownership. This approach attempts to optimize display space utilization, layout preservation, geographic awareness, and rectangle aspect ratio. There may be regions of the IP-space where detailed organizational and/or topographic data exists and a change in perspective can be used to enhance the display of this information.

The combination of a hierarchical organization of IP-space and a view-based visualization allows for other useful capabilities: zoom and layering. Zoom is useful for preserving the user's ability to assimilate information by reducing visual clutter and compressing large domains so they fit on a reasonable size display. In the IP domain, zoom is the aggregation/disaggregation of IP-space according to hierarchical tiers. Each dataset can determine the optimal manner in which to aggregate as the user demands broader/narrower views of the space. For example, numerical functions of IP-space might aggregate as sums, averages, min/max, pixel averaging, or through the use of thresholds. As zoom levels are increased such that individual IPs can be rendered as multiple pixels, symbols can be introduced to convey known element attributes.

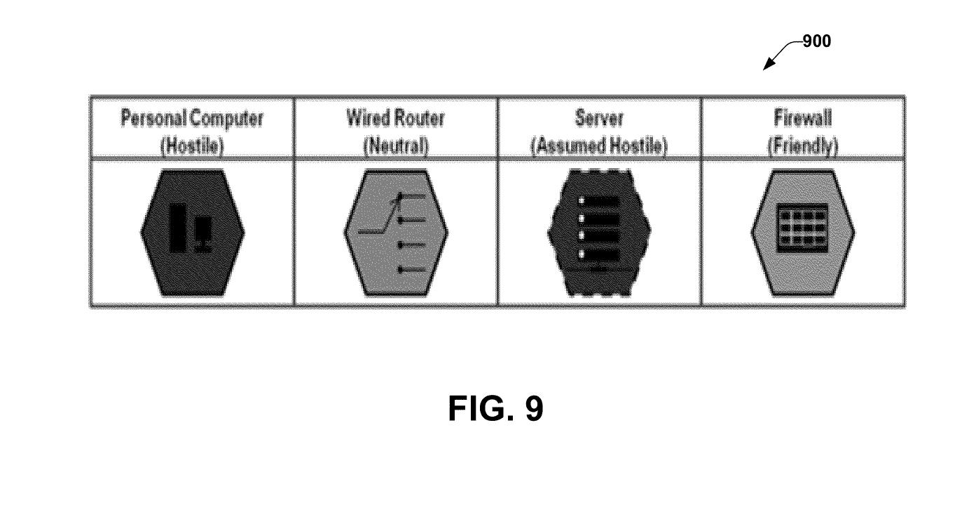

FIG. 9 illustrates an example output 900 depicting threat status symbols in accordance with an aspect of the present invention. The components of each symbol can be used to express different element attributes. This concept is embodied in MIL-STD 2525 which defines the composition, construction, and display of tactical symbols and tactical graphics for physical space displays. No extension of MIL-STD 2525, however, exists to cover the cyber domain. Until such a standard is adopted, the principles of symbology in MIL-STD 2525 can be extended on a best-effort basis to any cyber situational awareness tool and depicted in the output examples 500. A MIL-STD symbol consists of a frame outline, frame shape, optional fill color, icon, textual modifiers, and graphical modifiers. Frame outline (solid or dashed) conveys the certainty or timeliness of an element's position. Frame shape conveys the standard identity or threat (unknown, friend, neutral, and so forth) and battle dimension (land, sea, subsurface, space, and so forth) of the element. Fill color provides redundant information about standard identity.

The respective icon can convey the role or mission of the object which in the cyber domain can identify the network element as a personal computer, laptop, smart phone, VM, server, router, switch, firewall, intrusion detection system (IDS), and so forth. Modifiers can be placed around the symbol to show a variety of other attributes including status, mobility, affiliation, type, and movement. In addition to visualizing individual elements, MIL-STD 2525 also includes symbology for operations and tasking that can be extended into the cyber domain. A simple abstract, yet information dense, symbology has proven effective at enabling rapid assimilation of situational awareness information even when compared to more complex, realistic visualization alternatives.

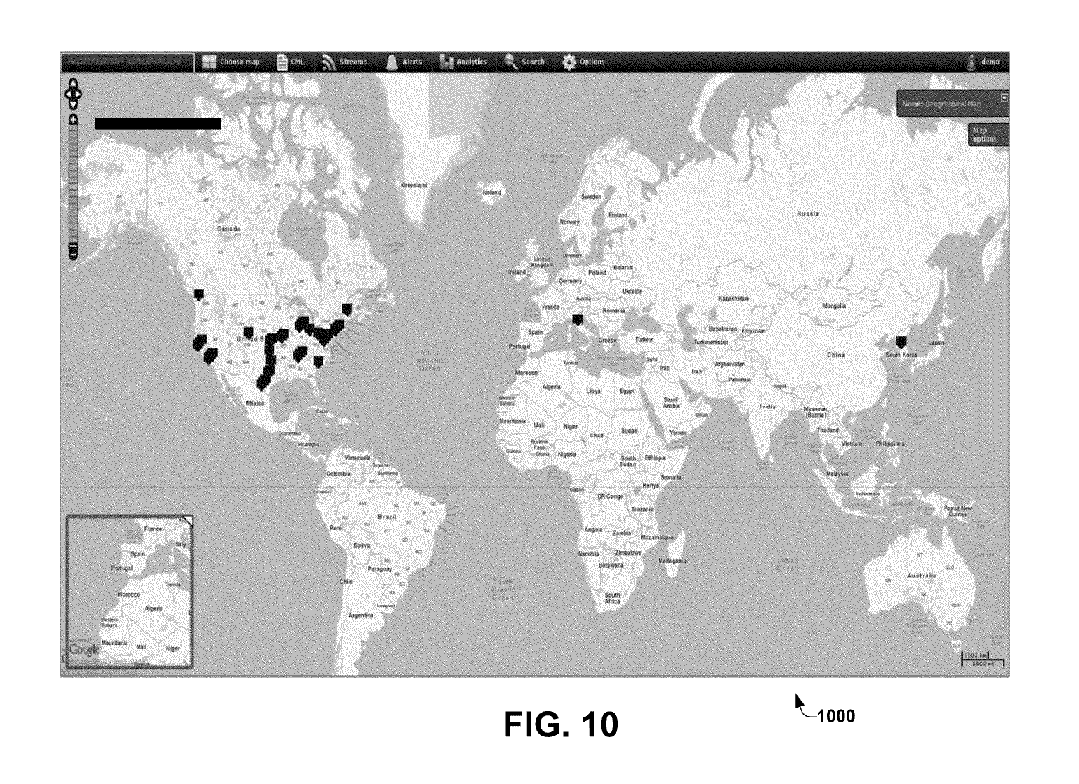

FIG. 10 illustrates an example geospatial situational awareness visualization 1000 in accordance with an aspect of the present invention. Layering is another technique useful for the user's ability to assimilate and correlate varied datasets. Layering provides a method of integrating multiple, disconnected data sources onto a common domain. Each data set, or layer, can be a function of the underlying domain space. Tools allow various layers to be viewed concurrently. Through the concurrent visualization of multiple layers, situational awareness is promoted. The framework that supports each layer is common which aids users in identifying overlaps and other interactions between the layers. Use of layers in geospatial visualizations is near ubiquitous as shown in the visualization 1000, yet, no existing cyber situational awareness tool has adopted the concept. The primary reason why layering is not used in CSA tools is the insistence that network data must be used to define element layout or visual characteristics versus being draped over some underlying organizational framework.

A layer can be composed of: 1) a list of IP addresses representing discrete points on the IP map; 2) lists of connected IP addresses representing lines or arcs on the IP map; or 3) IP address/number pairs representing attribute values at that IP address, for example. Similar to how locations of buildings (list), roads (lists of connected points), or altitude (point/value pairs) are functions of lat/long. A proposed hierarchical organization of IP-space provides the stable, complete, and data-agnostic framework on which layers can be draped. Each data source's layer remains decoupled from other sources, the hierarchical framework, and the user's view, yet they can be combined in substantially any user-defined combination to form a single, integrated visualization. Layers can be applied to both geospatial and IP space maps within the system 500 of FIG. 5, for example.

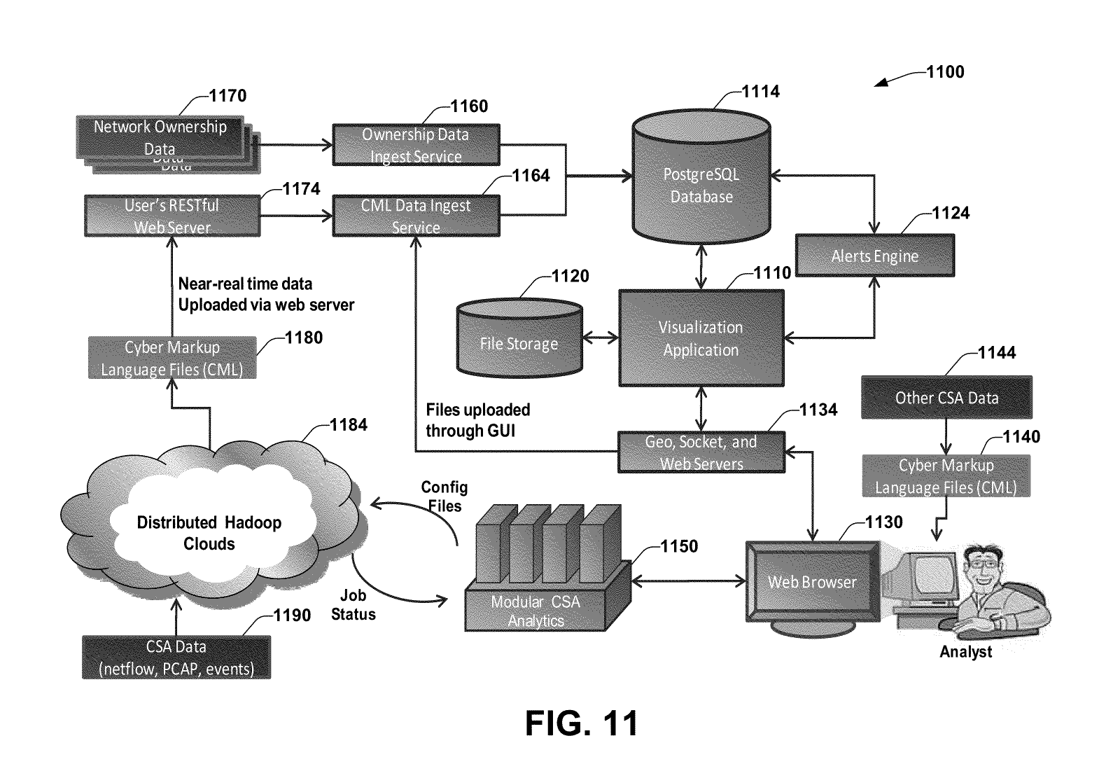

FIG. 11 illustrates an example system 1100 for analyzing and visualizing datasets in accordance with an aspect of the present invention. The system 1100 includes a visualization application 1110 that receives inputs from an SQL database 1114, local storage 1120, and an alerts engine 1124. The visualization application 1110 interacts with a web browser 1130 through a socket and servers 1134. The web browser enables an analyst to interact with the system 1100, wherein the analyst can operate on Cyber Markup Language (CML) files or other cyber data 1144 as previously described. The web browser 1130 can also load various analytic modules 1150 for analysis as previously described. The SQL database receives ownership data 1160 and CML data 1164 for processing by the visualization application 1110. The ownership data 1160 can include network data 1170. The CML data 1164 can be retrieved from a web server 1174. As shown, CML files 1180 can be uploaded from a network cloud 1184 which receives situational awareness data 1190 and exchanges configuration files and status with the analytic modules 1150.

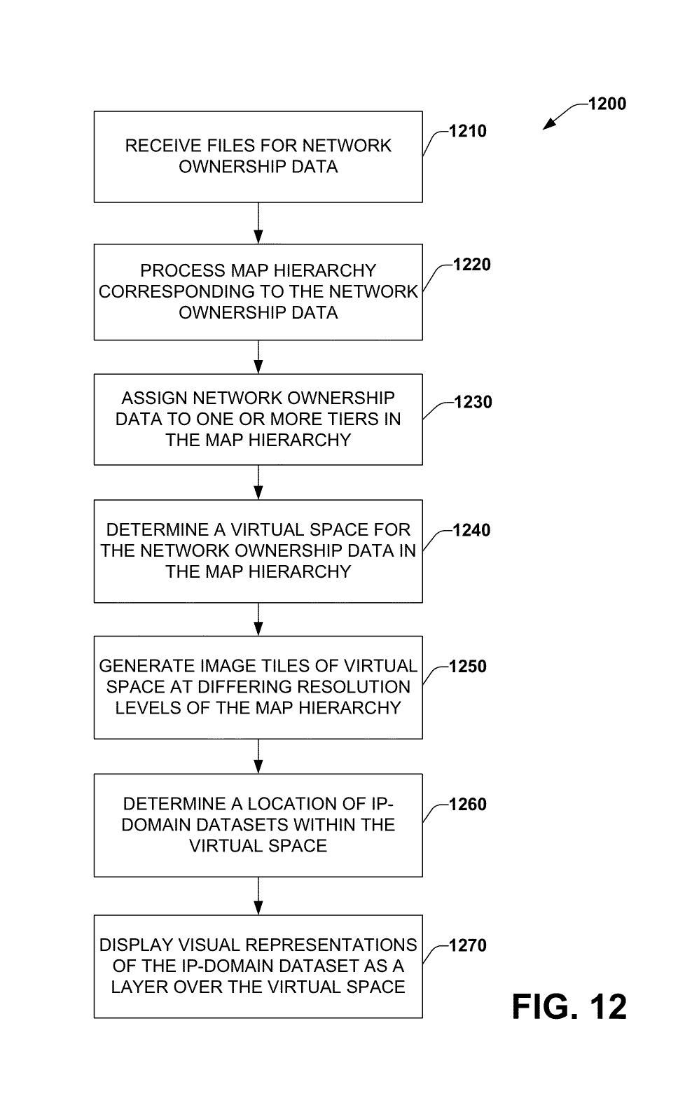

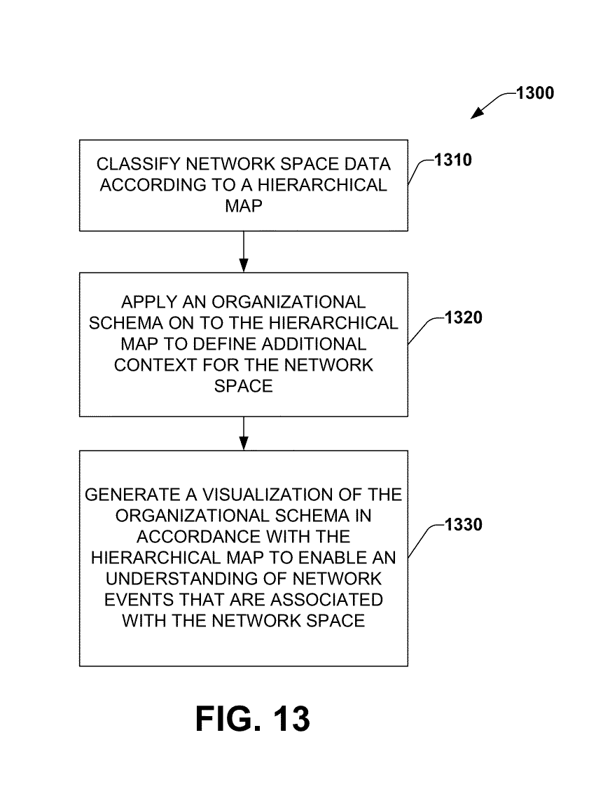

In view of the foregoing structural and functional features described above, a methodology in accordance with various aspects of the present invention will be better appreciated with reference to FIGS. 12 and 13. While, for purposes of simplicity of explanation, the methodologies of FIGS. 12 and 13 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 12 illustrates a methodology 1200 for map generation and dataset visualization in accordance with an aspect of the present invention. At 1210, the method 1200 includes receiving files for network ownership data. At 1220, the method 1200 includes processing a map hierarchy corresponding to the network ownership data. At 1230, the method 1200 includes assigning the network ownership data to one or more tiers in the map hierarchy. At 1240, the method 1200 includes determining a virtual space (e.g., 2D or 3D space) for the network ownership data in the map hierarchy. At 1250, the method 1200 includes generating image tiles of the virtual space at differing resolution levels of the map hierarchy. At 1260, the method 1200 includes determining a location of IP-domain datasets within the virtual space, or map. At 1270, the method 1200 includes displaying visual representations of the IP-domain dataset as a layer over the virtual space.

FIG. 13 illustrates a methodology 1300 for generating a visualization from configurable network space maps in accordance with an aspect of the present invention. At 1310, the method 1300 includes classifying network space data according to a hierarchical map (e.g., via CML language, API 110, and map module 130 of FIG. 1). At 1320, the method 1300 includes applying an organizational schema on to the hierarchical map to define additional context for the network space (e.g., via visualization module 140 of FIG. 1). At 1330, the method 1300 includes generating a visualization of the organizational schema in accordance with the hierarchical map to enable an understanding of network events that are associated with the network space (e.g., via map module 130 and visualization module 140 of FIG. 1).

The network space can be a set or subset of Internet Protocol (IP) addresses, for example. Although not shown, the method 1300 can also include creating tiles from different regions of a treemap. The tiles can be generated at multiple levels of resolution to provide a zoom visualization, for example. The method can also include generating a markup file describing the visualization. The markup file can be based on a cyber markup language (CML) that describes how data is to be visualized. This allows plotting geometrical patterns over renderings of a background map, for example. The geometrical patterns can include placemarks representing a single IP address, lines representing a block of IP addresses, or polygons representing the block of IP addresses. The organization schema can include at least one of a global tree, an autonomous system tree, a business tree, a persona tree, a location tree, and a mission tree, for example. The method can also include applying the organizational schema to a security application (e.g., cyber COP) that monitors incoming and outgoing events from the visualization.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A method comprising:
generating a treemap for a network space comprising an array of addresses, wherein the treemap comprises a hierarchical network map with a plurality of leaf nodes, and wherein each leaf node in the treemap characterizes a proper subset of the array of addresses;
overlaying an organizational schema for an organization on to the hierarchical network map to identify a plurality of nodes of the network space employed by the organization; and
generating a visualization for a graphical user interface (GUI) of the hierarchical network map with the organizational schema overlaid thereon that includes a visual indicia of events that occur within the network space.

2. The method of claim 1, wherein the network space is a subset of Internet Protocol (IP) addresses.

3. The method of claim 1, wherein generating the hierarchical network map further comprises creating tiles for the treemap of the hierarchical network map.

4. The method of claim 3, wherein the tiles are generated at multiple levels of resolution to provide a zoom visualization.

5. The method of claim 1, further comprising generating a markup file describing an address event visualization.

6. The method of claim 5, wherein the markup file is based on an eXtensible markup language (XML) that describes how data is to be visualized.

7. The method of claim 6, further comprising plotting geometrical patterns over renderings of a background map, wherein each geometrical pattern represents a proper subset of the array of addresses.

8. The method of claim 7, wherein the geometrical patterns include placemarks representing a single IP address, lines representing a block of IP addresses, or polygons representing the block of IP addresses.

9. The method of claim 1, wherein the generating the visualization further comprising creating a virtual display that scales to about a 1:1 ratio of pixels to number of IP addresses.

10. The method of claim 1, wherein the organization schema includes at least one of a global tree, an autonomous system tree, a business tree, a persona tree, a location tree, and a mission tree.

11. The method of claim 2, further comprising monitoring the organizational schema in a security application that determines security threats from incoming and outgoing events from the visualization.

12. The method of claim 2, wherein the hierarchical network map is configured in accordance with the organizational schema, such that the hierarchical network map includes each of the plurality of nodes of the network space employed by the organization.

13. The method of claim 12, wherein the hierarchical network map comprises a hierarchy based on network ownership data and the proper subset of the array of addresses of each leaf node of the hierarchical network map corresponds to the organizational schema.

14. The method of claim 13, wherein the network space comprises an Internet Protocol (IP)-space and the hierarchical network map comprises an IP-space map.

15. A system comprising:
a map module to generate a treemap for a network space comprising an array of network addresses, wherein the treemap comprises a hierarchical network map with a plurality of leaf nodes, and wherein each leaf node in the hierarchical network map characterizes a proper subset of the array of network addresses;
a markup language interface to specify an organizational schema for an organization and to identify a plurality of nodes of the network space employed by the organization; and
a visualization module to generate a visualization for a graphical user interface (GUI) of the hierarchical network map with the organizational schema overlaid thereon that includes a visual indicia of network events that occur within the network space.

16. The system of claim 15, wherein the network space is associated with an Internet Protocol (IP) space.

17. The system of claim 15, wherein the markup language interface generates extensible markup language that describes how data is to be visualized.

18. The system of claim 15, further comprising a database that receives location queries and element coordinates and generates element coordinates for the visualization.

19. The system of claim 18, a tile image server the element coordinates from the database and generates IP-space map tiles representing components of the visualization.

20. The system of claim 15, further comprising a client-side script processor to operate the markup language interface.

21. The system of claim 20, further comprising a server to process cyber markup language files from the client side processor and generate IP address coordinates for the client side processor.

22. A non-transitory computer readable medium comprising computer executable instructions that when executed cause a processor to:
generate a treemap for a network space comprising an array of network addresses, wherein the treemap comprises a hierarchical network map with a plurality of leaf nodes, and wherein each leaf node in the hierarchical network map characterizes a proper subset of the array of network addresses;
overlay an organizational schema for an organization on to the hierarchical network map to identify a plurality of nodes of the network space employed by the organization; and
generate a visualization for a graphical user interface (GUI) of the hierarchical network map with the organizational schema overlaid thereon that includes a visual indicia of network events that occur within the network space.

23. The non-transitory computer readable medium of claim 22, wherein the network space is associated with an Internet Protocol (IP) space.

24. A method comprising:
processing a network map hierarchy corresponding to network ownership data, wherein the network ownership data maps at least one of an address block of a network and an organizational name to an identifier;
assigning the network ownership data to at least one tier in the network map hierarchy;
determining a virtual space for the network ownership data in the network map hierarchy;
determining a location of a network dataset that characterizes an organizational schema within the virtual space; and
outputting a visual representation of the virtual space that includes an indicium identifying the determined location of the network dataset.

25. The method of claim 24, further comprising generating image tiles of the virtual space at different resolution levels of the network map hierarchy.
